(19) United States
(12) Patent Application Publication
(10) Pub. No.: US 2017/0110098 A1
(43) Pub. Date: Apr. 20, 2017

(54) PEDAL APPARATUS FOR PERCUSSION INSTRUMENT

(71) Applicant: YAMAHA CORPORATION, Hamamatsu-shi (JP)

(72) Inventor: Fumihiro SHIGENAGA, Hamamatsu-shi (JP)

(21) Appl. No.: 15/291,695

(22) Filed: Oct. 12, 2016

(30) Foreign Application Priority Data
Oct. 20, 2015 (JP) 2015-206379

(51) Int. Cl. G10D 13/00

(52) U.S. Cl. CPC G10D 13/006

(57) ABSTRACT

Disclosed is a percussion instrument pedal apparatus where a transmission mechanism is connectable to a foot board without use of an engaging member projecting from the reverse side of the foot board. The pedal apparatus includes: a foot board; a beater mounted on a pivot shaft and capable of striking a bass drum in response to pivoting of the pivot shaft; a chain member having a pivot-shaft connected section provided on one end thereof to transmit pivoting force to the pivot shaft; and a connection member pivotably mounted at one end to the distal end of the foot board and connected at the other end to the chain member, the connection member transmitting, to the chain member, pivoting force responsive to depression of the foot board.

The pivoting force transmitted to the chain member is then transmitted from the chain member to the pivot shaft.

### BACKGROUND

The present invention relates generally to pedal apparatus for use in performance of a percussion instrument, such as a bass drum of a drum set, and more particularly to an improvement in a structure for mounting a transmission mechanism to a foot board.

Pedal apparatus for percussion instruments (hereinafter also referred to simply as “percussion instrument pedal apparatus” or “pedal apparatus”) are used to perform a percussion instrument, such as a bass drum of a drum set. The pedal apparatus are constructed to strike a drum head of the bass drum by transmitting pivoting force, responsive to a depressing operation on a foot board, to a pivot shaft via a transmission mechanism so that a beater mounted on the pivot shaft pivots in response to pivoting of the pivot shaft.

As an example of the transmission mechanism in the pedal apparatus, there has been known a “chain-drive” type transmission mechanism which comprises a chain member. In the pedal apparatus employing the chain-drive type transmission mechanism, the chain member is fixed at one end to the underside or reverse side (or bottom surface) of the foot board by screws or the like and connected at the other end to the pivot shaft (see, for example, FIG. 3 of Japanese Patent Application Laid-open Publication No. 2006-343459).

As another example of the transmission mechanism, there has been known a “direct-drive” type transmission mechanism which comprises a transmission rod formed of metal, such as aluminum. In the pedal apparatus employing the “direct-drive” type transmission mechanism, a link mechanism is pivotably connected at one end to the distal end of the foot board and connected at the other end to the pivot shaft (see, for example, FIG. 1 of Japanese Patent Application Laid-open Publication No. 2003-255927).

Various other types of transmission mechanisms than the aforementioned have also been known, such as a belt-drive type transmission mechanism using a belt formed of a rubber material, nylon material, leather material or the like. As well known, an operating feel of the pedal apparatus, i.e. characteristics of striking motion like a moved amount of a beater responsive to a user's depressing operation, differs depending on the type of the transmission mechanism employed. A pedal apparatus with what type of transmission mechanism should be used depends mainly on a preference of the user.

In the conventionally-known pedal apparatus, the transmission mechanism and the foot board are interconnected directly, whatever the type of the transmission mechanism is. Therefore, depending on the type of the transmission mechanism, engaging members, such as screws, used to directly interconnect the transmission mechanism and the foot board may undesirably project from (or beyond) the underside or reverse side of the foot board toward an under plate. Thus, with the conventionally-known pedal apparatus, there would arise the problems that an adjustable range of the depressed amount of the foot board (i.e., pedal stroke) decreases due to the engaging members projecting from the reverse side of the foot board, and that the projecting engaging members collide against the under plate to damage the under plate, produce noise and cause other inconveniences.

Further, generally, in the conventionally-known pedal apparatus, the transmission mechanism cannot be replaced with a different type of transmission mechanism. Thus, when the user wants to use a plurality of different types of transmission mechanisms, it is necessary to prepare a separate pedal apparatus for each of the different types of transmission mechanisms. In this regard, “Falcon Single Bass Drum Pedal PF1000-Self-Adjusting Hoop Clamp—Interchangeable Beater Weights” by MAPEX DRUMS US, INC., 2015, which is available from the Internet at http://mapexdrums.com/us/products/hardware/bass-drum-pedals/single/pf1000/, discloses a pedal apparatus where different types of transmission mechanisms can be used interchangeably. However, in this case too, the transmission mechanism and the foot board are interconnected in the conventionally-known manner as noted above. Namely, the chain is connected at one end directly to the reverse side of the foot board by means of a screw or the like in the case of the chain-drive type transmission mechanism, and the link mechanism is connected at one end directly to the distal end of the foot board in the case of the direct-drive type transmission mechanism.

### SUMMARY OF THE INVENTION

In view of the foregoing prior art problems, it is an object of the present invention to provide an improved pedal apparatus for a percussion instrument in which the transmission mechanism and the foot board can be connected without use of an engaging member projecting from the reverse side of the foot board.

In order to accomplish the above-mentioned object, the present invention provides an improved pedal apparatus for a percussion instrument, which comprises: a striking mechanism mounted on a pivot shaft and constructed to strike a striking surface of the percussion instrument in response to pivoting of the pivot shaft; a foot board adapted for a depressing operation; a connection member pivotably mounted to the distal end of the foot board; and a transmission mechanism having a first end connected (coupled) to the connection member and a second end connected (coupled) to the pivot shaft, the transmission mechanism transmitting, to the pivot shaft, pivoting motion, responsive to depression of the foot board, received via the connection member.

According to the present invention, the connection member is pivotably mounted to the distal end of the foot board, and the transmission mechanism is connected at the first end to the connection member and connected at the second end to the pivot shaft of the striking mechanism. Pivoting motion or force responsive to a depression operation on the foot board is transmitted via the connection member to the transmission mechanism and then from the transmission mechanism to the pivot shaft. Then, in response to pivoting of the pivot shaft, the striking mechanism strikes the striking surface of the percussion instrument, such as a bass drum. Namely, in the present invention, the transmission mechanism is connected to the foot board via the connection member rather than being connected directly to the foot board. Therefore, whatever the type of the transmission mechanism employed in, or applied to, the pedal apparatus is, the transmission mechanism can be attached and detached to and from the connection member without the connection member being detached from the foot board. Thus, the mounting of the connection member to the foot board can be made fixed or semi-fixed, so that the present invention can eliminate a need for such a mounting structure where an engaging member, such as a screw, would undesirably project from the reverse side (underside or bottom surface) of the foot board. As a consequence, with the present invention, the transmission mechanism and the foot board can be interconnected without use of an engaging member projecting from the reverse side of the foot board. As an example, the connection member is pivotably mounted to the distal end of the foot board via a pivot (mounting shaft) extending in a generally horizontal direction. Because the pivot (mounting shaft) extends in a generally horizontal direction, it is possible to minimize a portion projecting vertically downward from the reverse side of the foot board.

In one embodiment, the transmission mechanism may comprise a chain, a link mechanism or a belt. In another embodiment, the connection member may be constructed to be capable of interchangeably connecting thereto different types of transmission mechanisms. Thus, a user can interchangeably use different types of transmission mechanisms on a single pedal apparatus, i.e. by possessing only one pedal apparatus. In another embodiment, the connection member may include a first position adjustment mechanism for adjusting a connected position between the connection member and the first end of the transmission mechanism. With such a simple position adjustment mechanism constructed to merely adjust the connected position between the connection member and the transmission mechanism, it is possible to adjust an angle of the foot board without changing an angle of the striking mechanism. In yet another embodiment, the second end of the transmission mechanism includes a second position adjustment mechanism for adjusting a connected position between the second end and the pivot shaft. By thus adjusting the connected position between the second end and the pivot shaft, it is possible to adjust a relative mounted position of the striking mechanism to the transmission mechanism.

With the percussion instrument pedal apparatus of the present invention, where the transmission mechanism is connected to the foot board via the connection member, it is possible to remove any engaging member, such as a screw, that projects from the reverse side of the foot board, whatever the type of the transmission mechanism applied to the pedal apparatus is. Thus, whatever the type of the transmission mechanism applied to the pedal apparatus is, the present invention can provide a longer pedal stroke than the conventionally-known pedal apparatus where the transmission mechanism is connected directly to the foot board. Further, the present invention can effectively prevent inconveniences, such as damage and noise, from occurring due to collision, against the under plate, of an engaging member, such as a screw, projecting from the reverse side of the foot board.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a side view, partly in section, showing an overall construction of a pedal apparatus for a percussion instrument according to a first embodiment of the present invention, which is provided with a “chain-drive” type transmission mechanism;

FIG. 2 is a front view of the pedal apparatus shown in FIG. 1;

FIG. 3 is an enlarged perspective view of a connection member taken in a direction of arrow A of FIG. 1;

FIG. 4 is a top plan view of the connection member taken in a direction of arrow B of FIG. 3;

FIG. 5 is a side view of the connection member taken in a direction of arrow C of FIG. 4;

FIG. 6A is a perspective view of a chain member taken in the direction of arrow A of FIG. 1, and FIG. 6B is a perspective view of the chain member taken in a direction of arrow D of FIG. 6A;

FIG. 7 is an enlarged perspective view of a rocker member taken in the direction of arrow A of FIG. 1;

FIG. 8 is a side view, partly in section, of an example overall construction of a percussion instrument pedal apparatus according to a second embodiment of the present invention, which is provided with a “direct-drive” type transmission mechanism in the form of a link mechanism;

FIG. 9A is a perspective view of the link mechanism taken in a direction of arrow E FIG. 8, and FIG. 9B is a perspective view of the link mechanism taken in a direction of arrow F of FIG. 9A; and

FIG. 10 is a view explanatory of another example construction of a position adjustment mechanism for adjusting a connected position between the connection member and the transmission mechanism.

### DETAILED DESCRIPTION

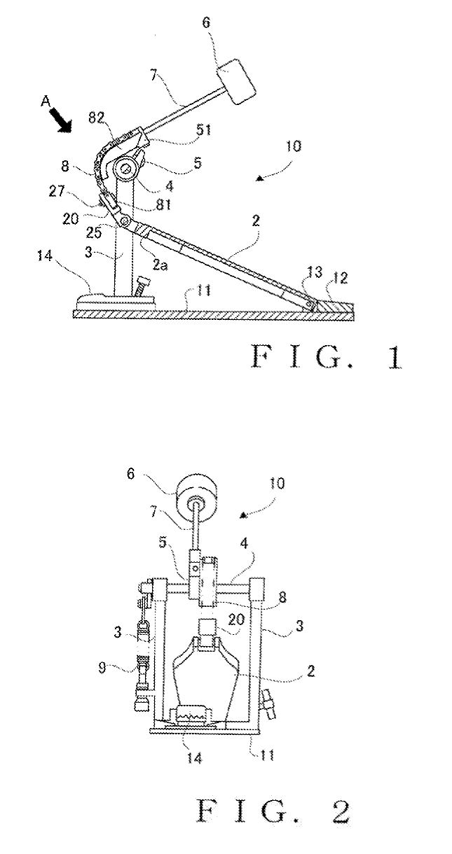

FIG. 1 is a side view, partly in section, showing an overall construction of a pedal apparatus 10 for a percussion instrument (“percussion instrument pedal apparatus 10” or “pedal apparatus 10”) according to a first embodiment of the present invention, which is provided with a “chain-drive” type transmission mechanism, and FIG. 2 is a front view of the percussion instrument pedal apparatus 10 shown in FIG. 1. The percussion instrument pedal apparatus 10 is used, for example, to play or perform a bass drum of a drum set. In the following description, terms “forward”, “rearward”, “upward” and “downward” are used to refer to directions as viewed when the pedal apparatus 10 is placed on a horizontal floor surface; for example, “leftward” in FIG. 1 corresponds to a “forward” direction of the pedal apparatus 10, and “upward” in FIG. 1 corresponds to an “upward” direction of the pedal apparatus 10.

As shown in FIGS. 1 and 2, the pedal apparatus 10 includes: a foot board 2 adapted for a depressing operation by a human player; a pivot shaft 4 pivotably supported on and between the respective upper ends of a pair of left and right struts 3; a striking mechanism including a beater shaft 7 mounted to a rocker member 5 fixedly mounted on an axially middle portion of the pivot shaft 4, and a beater 6 mounted to the distal end of the beater shaft 7; a chain member 8 that is a transmission mechanism for transmitting pivoting force to the pivot shaft 4; and a connection member 20 pivotably mounted to the distal end of the foot board 2. The transmission mechanism (chain member 8) is connected at its first end (connection-member connected section 81) to the connection member 20 so that pivoting force responsive to a depressing operation performed on the foot board 2 is transmitted via the connection member 20 to the transmission mechanism (chain member 8). Further, the transmission mechanism (chain member 8) is connected at its second end (pivot-shaft connected section 82) to the pivot shaft 4 so that pivoting motion responsive to a depressing operation on the foot board 2, received via the connection member 20, is transmitted to the pivot shaft 4.

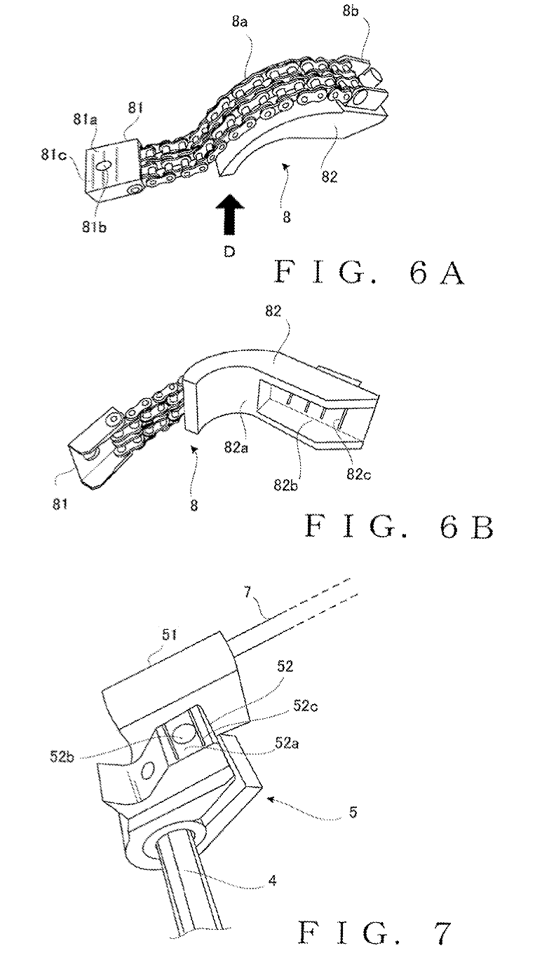

The foot board 2 is formed of a flat plate having a size large enough for the human player to place thereon his or her foot, and the foot board 2 is pivotably connected at its rear end, via a hinge section 13, to a heel section 12 provided on an under plate 11. The connection member 20 is pivotably connected to the front end of the foot board 2, as noted above. Further, the chain member 8 is detachably connected to the pivot shaft 4 (more specifically, to the rocker member 5) via the pivot-shaft connected section 82 (see FIGS. 6A and 6B) provided on the upper end (second end) of the chain member 8, and also the chain member 8 is detachably connected to the connection member 20 via the connection-member connected section 81 provided on the lower end (first end) of the chain member 8.

The rocker member 5 is mounted on the pivot shaft 4 in such a manner as to be pivotable together with the pivot shaft 4, and the rocket member 5 includes a shaft fixing section 51. The striking mechanism, including the beater shaft 7 and the beater 6, is connected to the pivot shaft 4 by the beater shaft 7 being fixed to the shaft fixing section 51. Further, the pedal apparatus 10 is mounted to a bass drum (not shown) by means of a hoop clamp 14, provided on a front end portion of the under plate 11, so that a striking surface of the bass drum is located in front of the pedal apparatus 10.

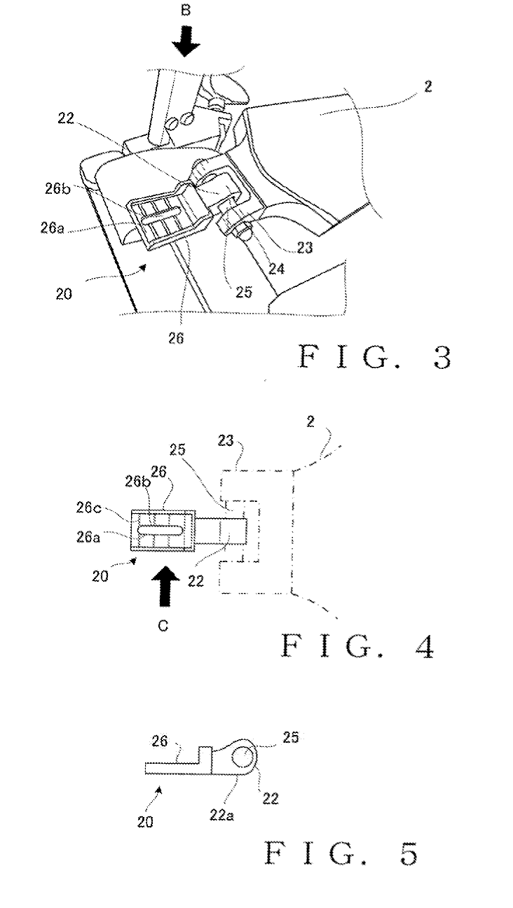

Next, an example construction of the connection member 20 will be described with reference to FIGS. 3 to 5. FIG. 3 is an enlarged perspective view of the connection member 20 taken in a direction of arrow A of FIG. 1 with the chain member 8 removed for clarity, FIG. 4 is a top plan view of the connection member 20 taken in a direction of arrow B of FIG. 3, and FIG. 5 is a side view of the connection member 20 taken in a direction of arrow C of FIG. 4. The connection member 20 has a through-hole 24 formed in one end portion 22 thereof. The connection member 20 is connected to a front end portion 23 of the foot board 2 by means of a mounting shaft 25 passed through the through-hole 24; the front end portion 23 has a generally U shape as viewed in top plan. The mounting shaft 25 constitutes a pivot of the connection member 20 and extends in a generally horizontal direction in substantially parallel relation to the pivot shaft 4. The one end portion 22 of the connection member 20 can be formed in a shape and size such that the reverse side (underside) 22a (FIG. 5) of the one end portion 22 projects as little as possible from the reverse side 2a (FIG. 1) of the foot board 2 with the connection member 20 assembled to the pedal apparatus 10. Further, because the only part of the connection member 20 connected to the distal end portion of the foot board 2 is the mounting shaft (pivot) 25 located on the one end portion 22 of the connection member 20 and because the mounting shaft (pivot) 25 extends in a generally horizontal direction, the connection member 20 can be easily formed in a shape and size such that the connected part of the connection member 20 projects as little as possible from the reverse side 2a (FIG. 1) of the foot board 2.

In the illustrated example, the connection member 20 is mounted to the front end portion 23 of the foot board 2 via a bearing (not shown). For example, the bearing (not shown) for pivotably supporting the mounting shaft 25 is incorporated in the through-hole 24 of the connection member 20. In this case, the mounting shaft 25 is fixed at its opposite ends to opposed legs of the front end portion 23 of the foot board 2 in such a manner that the connection member 20 is pivotable relative to the mounting shaft 25. As another example, bearings for pivotably supporting the opposite ends of the mounting shaft 25 are incorporated in the legs of the front end portion 23 of the foot board 2. Namely, in such a case, the mounting shaft 25 is pivotably mounted to the front end portion 23 of the foot board 2, and the connection member 20 is pivotable relative to the foot board 2 together with the mounting shaft 25. Mounting the connection member 20 to the front end portion 23 of the foot board 2 via the bearing as noted above permits smoother pivoting movement of the connection member 20 relative to the foot board 2 and can thereby achieve an enhanced operability of the pedal apparatus 10.

Further, the connection member 20 includes a coupling section 26 for coupling or connecting to the connection-member connected section 81 of the chain member 8. The coupling section 26, which extends from the one end portion 22 generally perpendicularly to the mounting shaft 25, has an upper surface 26a, left and right side wall portions projecting from the left and right side edges of the upper surface 26a, a rear wall portion projecting from the rear end edge of the upper surface 26a, and a screw hole 26b formed in a substantial central region of the upper surface 26a.

Further, FIGS. 6A and 6B show an example construction of the chain member 8, of which FIG. 6A is a perspective view of the chain member 8 taken in the direction of arrow A of FIG. 1 and FIG. 6B is a perspective view of the chain member 8 taken in a direction of arrow D of FIG. 6A. As shown in FIGS. 6A and 6B, the chain member 8 comprises a chain 8a, the connection-member connected section 81 provided on the lower end (first end) of the chain 8a, and the pivot-shaft connected section 82 provided on the upper end (second end) 8b of the chain 8a.

The connection-member connected section 81 has such a shape as to fit the coupling section 26 of the connection member 20, i.e. as to fit in the interior of the coupling section 26 located between the left and right side wall portions of the coupling section 26. The connection-member connected section 81 also has a screw hole 8 lb formed in a substantial central region of the upper surface 81a thereof. To connect the chain member 8 to the connection member 20, the upper surface 81a of the connection-member connected section 81 is abutted against the upper surface 26a (FIGS. 3 and 4) of the coupling section 26, and a screw 27 (FIG. 1) is screwed in (engaged in) both the screw hole 81b and the screw hole 26b (FIGS. 3 and 4) to thereby fasten the connection-member connected section 81 to the coupling section 26.

In the instant embodiment, the coupling section 26 of the connection section 20 includes a first position adjustment mechanism that adjusts a position where the coupling section 26 connects to the chain member 8, i.e. connected between the coupling section 26 and the chain member 8 or connected position of the chain member 8 relative to the connection member 20. To constitute such a first position adjustment mechanism, for example, the screw hole 26b of the connection member 20 is formed as an elongated hole (see FIGS. 3 and 4), and two sets of positioning projections 26c and 81c engageable with each other are formed respectively on the upper surface 26a of the coupling section 26 of the connection member 20 and the upper surface 81a of the connection-member connected section 81 of the chain member 8. The elongated hole 26b extends (i.e., is elongated) in a pivoting-force (pivoting-motion) transmitting direction, or along the length of a pivoting-force (pivoting-motion) transmitting path from the first end to the second end, of the chain member 8. The connected position of the chain member 8 relative to the connection member 20 is adjustable within a range permitted by the length of the elongated hole 26b. The connected position of the chain member 8 relative to the connection member 20 can be determined and adjusted (adjustably determined) stepwise among a plurality of positions defined by the two sets of positioning projections 26c and 81c formed respectively on the upper surface 26a of the coupling section 26 and the upper surface 81a of the connection-member connected section 81.

Such a simple adjustment mechanism constructed to merely adjust the connected position of the chain member 8 relative to the connection member 20 permits adjustment of a relative mounted position of the foot board 2 to the chain member 8. Thus, it is possible to adjust an angle of the foot board 2 relative to the floor surface without changing a pivotal position of the rocker member 5 (i.e., angle of the beater 6). More specifically, as the connected position of the chain member 8 relative to the connection member 20 is brought closer to the front end portion 23 of the foot board 2, the angle of the foot board 2 relative to the floor surface increases (namely, the front end portion 23 of the foot board 2 rises in position). Conversely, as the connected position of the chain member 8 is brought farther from the front end portion 23 of the foot board 2, the angle of the foot board 2 relative to the floor surface decreases (namely, the front end portion 23 of the foot board 2 lowers in position). Namely, the angle of the foot board 2 relative to the floor surface is adjustable by the first position adjustment mechanism that adjusts the connected position of the chain member 8 relative to the connection member 20.

The chain 8a is fixed at the upper end portion 8b to the pivot-shaft connected section 82, for example, by means of a screw (not shown). The pivot-shaft connected section 82 has, as a whole, an arcuately curved shape corresponding to a pivoting trajectory of the pivot shaft 4 and is constructed so that movement or motion of the chain member 8 responsive to a depressing operation on the foot board 2 can be transmitted smoothly to the pivot shaft 4 via the pivot-shaft connected section 82. Further, the pivot-shaft connected section 82 has a concave portion 82b formed in the reverse side 82a for engaging with the rocker member 5, and a screw hole (not shown) is formed in the concave portion 82b. FIG. 7 is an enlarged perspective view of the rocker member 5 taken in the direction of arrow A of FIG. 1, with the chain member 8 removed for clarity. The rocker member 5 has an engaging portion 52 for engaging with the concave portion 82b of the pivot-shaft connected section 82, and a screw hole 52b formed in the upper surface 52a thereof. To connect the chain member 8 to the rocker 5, the concave portion 82b of the pivot-shaft connected section 82 is brought into engagement with the engaging portion 52 of the rocker member 5, and a screw 27 (FIG. 1) is screwed in, or engaged in, both the screw hole (not shown) of the concave portion 82b and the screw hole 52b of the engaging portion 52 to thereby fasten the pivot-shaft connected section 82 to the engaging portion 52. In this manner, the second end (pivot-shaft connected section 82) has a structure matching the rocker member 5 that pivots together with the pivot shaft 4.

Further, in the instant embodiment, the pivot-shaft connected section 82 includes a second position adjustment mechanism that adjusts a connected position of the chain member 8 relative to the rocker member 5. For example, to constitute such a second position adjustment mechanism, the screw hole (not shown) of the concave portion 82b of the pivot-shaft connected section 82 is formed as an elongated hole. The elongated hole of the concave portion 82b extends (is elongated) along the length of the pivoting-force (pivoting-motion) transmitting path of the chain member 8. The connected position of the pivot-shaft connected section 82 relative to the rocker member 5, in other words the connected position between the chain member 8 and the pivot shaft 4, is adjustable within a range permitted by the length of the elongated hole of the concave portion 82b. Further, two sets of positioning projections 82c and 52c are formed respectively on mutually-abutting surfaces of the concave portion 82b of the pivot-shaft connected section 82 and the engaging portion 52 of the rocker member 5, so that the connected position of the pivot-shaft connected section 82 relative to the rocker member 5 can be determined and adjusted (adjustably determined) stepwise among a plurality of positions defined by the two sets of positioning projections 82c and 52c. By changing a connected position between the chain member 8 and the rocker member 5, it is possible to adjust a relative mounted position between the chain member 8 and the rocker member 5. Namely, the second position adjustment mechanism for adjusting the connected position of the chain member 8 relative to the rocker member 5 is capable of adjusting a relative mounted position between the chain member 8 and the beater 6. By thus adjusting the relative mounted position between the chain member 8 and the beater 6, it is possible to adjust motion characteristics of the beater 6 responsive to a depressing operation performed on the foot board 2, i.e. depressing feel of the pedal apparatus 10.

The following describe behavior of the pedal apparatus 10 constructed in the aforementioned manner. The chain-drive type pedal apparatus 10 shown in FIG. 1 etc. is in a state where no depressing operation is being performed on the foot board 2. As the user depresses the foot board 2 with his or her foot, the foot board 2 pivots about the hinge section 13 in an up-to-down direction in such a manner that the front end of the foot board 2 moves downward. Thus, the chain member 8 is moved downward via the connection member 20 connected to the front end of the foot board 2, so that the pivot shaft 4 pivots counterclockwise of FIG. 1. Namely, pivoting force responsive to the depressing operation on the foot board 2 is transmitted via the connection member 20 to the chain member 8 and thus causes the rocker member 5, fixed to the chain member 8, to pivot about the pivot shaft 4, so that the pivoting force is transmitted to the pivot shaft 4. Then, by the shaft fixing section 51, fixed to the pivot shaft 4, pivoting forward (in the counterclockwise direction in FIG. 1) in response to the pivoting movement of the pivot shaft 4, the beater 6 mounted to the distal end of the beater shaft 7 strikes the head of the bass drum (not shown) disposed in front of the pedal apparatus 10. As the user removes the depressing force from the foot board 2, the foot board 2 returns to an initial non-depressed position shown in FIG. 1 by resilient upward returning force of a returning spring 9 (FIG. 2) connected to one end of the pivot shaft 4.

Because the chain member 8 is connected to the foot board 2 via the connection member 20, the first embodiment of the pedal apparatus 10 constructed in the aforementioned manner can eliminate the need for any component part, such as an engaging member like a screw, that is needed in the conventionally-known pedal apparatus to connect one end portion of the chain directly to the foot board but undesirably projects from the reverse side of the foot board. Thus, as compared to the conventionally-known pedal apparatus where the one end portion of the chain is connected directly to the reverse side of the foot board, the embodiment of the pedal apparatus 10 can provide a longer pedal stroke. Besides, the first embodiment of the pedal apparatus 10 can effectively prevent inconveniences, such as damage and noise, from occurring due to collision, against the under plate 11, of a screw etc. projecting from the reverse side of the foot board 2.

Further, FIG. 8 is a side view, partly in section, of an example overall construction of a percussion instrument pedal apparatus according to a second embodiment of the present invention, which is provided with a “direct-drive” type transmission mechanism. The second embodiment, i.e. “direct-drive” type percussion instrument pedal apparatus 10, shown in FIG. 8 is constructed substantially similarly to the first embodiment, i.e. “chain-drive” type percussion instrument pedal apparatus 10, shown in FIG. 1, except that it includes a link mechanism 80 as the transmission mechanism. The same or like elements as in the “chain-drive” type percussion instrument pedal apparatus 10 shown in FIG. 1 are represented by the same reference numerals as used for the “chain-drive” type percussion instrument pedal apparatus 10 and will not be described here to avoid unnecessary duplication. In the “direct-drive” type percussion instrument pedal apparatus 10 shown in FIG. 8, the link mechanism 80 is connected at its lower end (first end) to the upper end of the connection mechanism 20 connected to the front end of the foot board 2, and the link mechanism 80 is connected at its upper end (second end) to the pivot shaft 4 via a pivot-shaft connected section 84 provided on the upper end (second end). Pivoting force responsive to a depressing operation performed on the foot board 2 is transmitted via the connection member 20 to the link mechanism 80, so that the link mechanism 80 transmits the pivoting force to the pivot shaft 4.

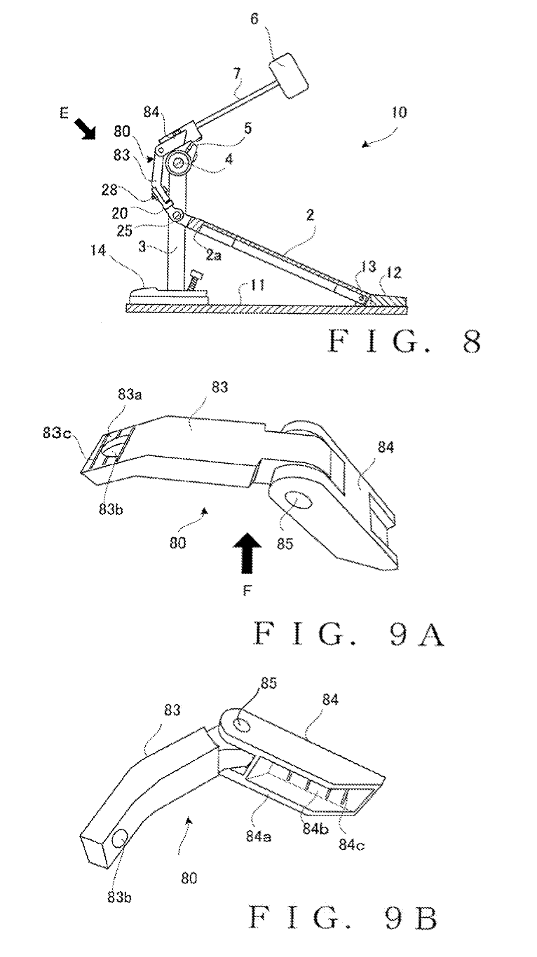

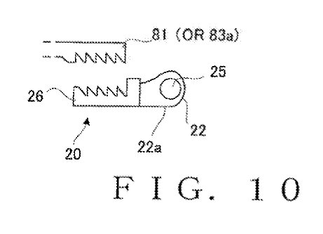

FIGS. 9A and 9B are fragmentary enlarged perspective views of the link mechanism 80, of which FIG. 9A shows the link mechanism 80 taken in a direction of arrow E of FIG. 8 and FIG. 9B shows the link mechanism 80 taken in a direction of arrow F of FIG. 9A. The link mechanism 80 includes a transmission rod 83 die-cast of metal, such as aluminum, and the pivot-shaft connected section 84 for connection to the pivot shaft 4, and an upper end portion of the transmission rod 83 and a lower end portion of the pivot-shaft connected section 84 are pivotably interconnected.

The transmission rod 83 has a connection-member connected section 83a formed on its lower end for connection to the connection member 20. The connection-member connected section 83a has a shape fitting that of the coupling section 26 (FIG. 3) of the connection member 20, and the connection-member connected section 83a has a screw hole 83b. To connect the link mechanism 80 to the connection member 20, the upper surface of the connection-member connected section 83a is abutted against the upper surface 26a (FIGS. 3 and 4) of the coupling section 26, and a screw 28 (FIG. 8) is screwed in, or engaged in, both the screw hole 83b and the screw hole 26b (FIGS. 3 and 4) to thereby fasten the transmission rod 83 to the connection member 20.

Further, a connected position between the connection member 20 and the link mechanism 80 too is adjustable within a range permitted by the length of the elongated hole 26b extending (or elongated) along the length of the pivoting-force (pivoting-motion) transmitting path from the first end to the second end of the link mechanism 80. Further, a plurality of engaging or positioning projections 83c are formed on the connection-member connected section 83a too, so that the connected position between the connection member 20 and the link mechanism 80 can be determined and adjusted stepwise among a plurality of positions defined by the two sets of engaging projections 26c and 83c of the coupling section 26 and the connection-member connected section 83a. With the conventionally-known direct-drive type pedal apparatus, where the link mechanism is connected directly to the foot board, adjustment of the connected position between the link mechanism and the foot board cannot be achieved with a simple mechanism. By contrast, with the direct-drive type pedal apparatus 10 of the present invention provided with the link mechanism 80, it is possible to adjust the mounted position of the foot board relative to the link mechanism 80 with the simple mechanism of adjusting the connected position of the link mechanism 80 to the connection member 20.

Further, the pivot-shaft connected section 84 provided on the upper end of the link mechanism 80 has a concave portion 84b formed in its underside 84a and engageable with the engaging portion 52 (FIG. 7) of the rocker member 5. To connect the pivot-shaft connected section 84 to the rocker member 5, the concave portion 84b is mounted to the engaging portion 52, and a screw (not shown) is screwed in, or engaged in, both a screw hole (not shown) of the concave portion 84b and the screw hole 52b of the engaging portion 52. Namely, in the “direct-drive” type pedal apparatus 10 too, the second end (pivot-shaft connected section 84) has a structure matching the rocker 5 that is pivotable together with the pivot shaft 4.

The pivot-shaft connected section 84 of the link mechanism 80 too may include a position adjustment mechanism for adjusting a connected position of the link mechanism 80 relative to the rocker member 5. Namely, the screw hole (not shown) of the concave portion 84b is formed as an elongated hole extending along the length of the pivoting-force transmitting path, and the connected position of the link mechanism 80 relative to the rocker member 5 can be adjusted within a range permitted by the length of the elongated hole. Further, as shown in FIGS. 9A and 9B, a plurality of engaging projections 84c are formed on the concave portion 84b too, so that the connected position of the link mechanism 80 relative to the rocker member 5 can be determined and adjusted stepwise among a plurality of positions defined by the two sets of engaging projections 84c and 52c.

The connection member 20 employed in the present invention can interchangeably connect thereto different types of transmission mechanisms, more specifically the aforementioned chain member 8 and the link mechanism 80. Namely, the coupling section 26 of the connection member 20 is constructed to match either of the connection-member connected sections 81 and 83a provided on the end portions of the chain member 8 and the link mechanism 80. Thus, the user can selectively use either one of the “chain-drive” type pedal apparatus and the “direct-drive” type pedal apparatus by merely changing, as necessary, the transmission mechanism to be connected to the connection member 20. Attachment and detachment of the transmission mechanisms 8 and 80 to and from the connection member 20 can be effected with utmost ease by attaching and detaching the screw to and from a desired position of the coupling section 26 located forward of the front end of the foot board 2. Thus, the user can easily attach and detach the transmission mechanisms 8 and 80 to and from the connection member 20 without performing cumbersome operation, such as extending a hand under the foot board 2 to attach and detach the screw. As known in the art, the “chain-drive” type pedal apparatus and the “direct-drive” type pedal apparatus differ from each other in operating feel, such as characteristics of striking motion of the beater 6 like a moved amount of the beater responsive user's depressing operation. Allowing the user to select any one of different types of transmission mechanisms is very convenient to the user in that any one of different types of pedal apparatus, differing from each other in operating feel, can be used easily without involving cumbersome labor, such as preparing in advance different types of pedal apparatus and then replacing one type of pedal apparatus with another as needed.

Further, it should be appreciated that the present invention is not necessarily limited to the above-described embodiments and may be modified variously within the scope of the technical idea disclosed in the claims, specification and drawings.

For example, the means for connecting the transmission mechanism 8 or 80 to the connection member 20 are not limited to the screw and screw hole as set forth above and may be any conventionally-known engagement means as long as they can appropriately connect the transmission mechanism 8 or 80 to the connection member 20. Further, the coupling section 26 of the connection member 20 may have any other shape than illustrated in the drawings.

Further, the position adjustment mechanism for adjusting the connected position between the connection member 20 and each of the transmission mechanisms 8 and 80 is not necessarily limited to the one where the screw hole 26b is formed as an elongated hole extending along the length of the pivoting-force transmitting path and may be one where the screw hole 81b or 83b of each of the transmission mechanisms 8 and 80 rather than the screw hole 26b is formed as an elongated hole. As another example, the respective abutting surfaces of the coupling section 26 of the connection member 20 and the connection-member connected section 81 or 83a of each of the transmission mechanisms 8 and 80 may be formed as fitting surfaces having mutually-engageable projections and recesses (concavities and convexities) and either the screw hole 26b of the connection member 20 or the screw hole 81b or 83b of each of the transmission mechanisms may be formed as an elongated hole extending along the length of the pivoting-force transmitting path so that the connected position between the connection member 20 and the transmission mechanism 8 or 80 can be determined and adjusted (adjustably determined) stepwise among a plurality of fitting positions on the fitting surface. As still another example, at least one of the connection member 20 and the transmission mechanism 8 or 80 may have a plurality of screw holes formed therein in a row extending in a connected-position adjusting direction (i.e., along the length of the pivoting-force transmitting path) so that the connected position between the connection member 20 and the transmission mechanism 8 or 80 is adjustable stepwise by engagement means, such as a screw, engaging any one of the screw holes.

Furthermore, the position adjustment mechanism for adjusting the connected position between each of the transmission mechanisms 8 and 80 and the pivot shaft 4 too may be modified variously similarly to the aforementioned various modifications of the position adjustment mechanism for adjusting the connected position between the connection member 20 and each of the transmission mechanisms 8 and 80.

Furthermore, whereas the foregoing have described the positioning mechanism where the connected position between the connection member 20 and the transmission mechanism 8 or 80 is adjustably determined by the projections 26c and the projections 81c or 83c, each having a saw tooth shape for example, that are complementary in shape, the positioning mechanism may be constructed in any other manner; for example, the positioning mechanism may comprise a combination of other forms of projections and recesses (convexities and concavities) having desired shapes and yet fittingly engageable with each other, as long as it permits engagement between the connection mechanism 20 and the transmission mechanism 8 or 80 selectively at any one of predetermined positions.

Furthermore, whereas the foregoing have described the positioning mechanism where the connected position between the transmission mechanism 8 or 80 and the rocker member 5 is adjustably determined by the projections 82c or 84c, each having a saw tooth shape for example, that are complementary in shape, the positioning mechanism may be constructed in any other manner; for example, the positioning mechanism may comprise a combination of other forms of projections and recesses (convexities and concavities) having desired shapes and yet fittingly engageable with each other, as long as it permits engagement between the transmission mechanism 8 or 80 and the rocker member 5 selectively at any one of predetermined positions.

Furthermore, the coupling section 26 employed in the present invention need not necessarily be a single coupling section capable of interchangeably connecting thereto different types of transmission mechanisms. Namely, in the present invention, separate coupling sections, differing in shape and construction from one another, may be employed for the individual types of transmission mechanisms, with each of the coupling sections having a shape and construction unique to any one of the types of transmission mechanisms.

Furthermore, the transmission mechanisms employed in the present invention are not limited to the chain-drive type and the direct-drive type and may be any other conventionally-known types, such as a belt-drive type that uses a belt formed of a rubber material, nylon material, leather material or the like.

This application is based on, and claims priority to, JP PA 2015-206379 filed on 20 Oct. 2015. The disclosure of the priority application, in its entirety, including the drawings, claims, and the specification thereof, are incorporated herein by reference.

What is claimed is:

1. A pedal apparatus for a percussion instrument comprising:
a striking mechanism mounted on a pivot shaft and constructed to strike a striking surface of the percussion instrument in response to pivoting of the pivot shaft;
a foot board adapted for a depressing operation;
a connection member pivotably mounted to a distal end of the foot board; and
a transmission mechanism having a first end connected to the connection member and a second end connected to the pivot shaft, the transmission mechanism transmitting, to the pivot shaft, pivoting motion, responsive to depression of the foot board, received via the connection member.

2. The pedal apparatus for a percussion instrument as claimed in claim 1, wherein the transmission mechanism is constructed in such a manner that the first end is detachably connected to the connection member and the second end is detachably connected to the pivot shaft.

3. The pedal apparatus for a percussion instrument as claimed in claim 2, wherein the connection member is constructed to be capable of interchangeably connecting thereto different types of transmission mechanisms.

4. The pedal apparatus for a percussion instrument as claimed in claim 2, which further comprises a rocker member mounted on the pivot shaft, and the second end of the transmission mechanism has a structure matching the rocker member.

5. The pedal apparatus for a percussion instrument as claimed in claim 1, wherein the connection member is pivotably mounted to the distal end of the foot board via a pivot extending in a generally horizontal direction.

6. The pedal apparatus for a percussion instrument as claimed in claim 1, wherein the transmission mechanism is constructed in such a manner that a pivoting-motion transmitting path thereof from the first end to the second end is adjustable in length.

7. The pedal apparatus for a percussion instrument as claimed in claim 6, wherein the transmission mechanism is connected to the connection member or the pivot shaft with at least one of the first end and the second end thereof selectively positioned at any one of a plurality of different mounting positions provided along a length of the pivoting-motion transmitting path.

8. The pedal apparatus for a percussion instrument as claimed in claim 1, wherein the connection member includes a first position adjustment mechanism for adjusting a connected position between the connection member and the first end of the transmission mechanism.

9. The pedal apparatus for a percussion instrument as claimed in claim 8, wherein the first position adjustment mechanism includes a plurality of engaging projections for adjusting the connected position between the connection member and the first end of the transmission mechanism stepwise along the length of the pivoting-motion transmitting path.

10. The pedal apparatus for a percussion instrument as claimed in claim 8, wherein the first position adjustment mechanism includes an elongated hole extending along a length of a pivoting-motion transmitting path of the transmission mechanism from the first end to the second end, and the first position adjustment mechanism connects the first end of the transmission mechanism to the connection member by an engaging member inserted and engaged in both a desired position of the elongated hole and an engaging hole that is formed in the first end of the transmission mechanism and positioned in superimposed alignment with the desired position of the elongated hole.

11. The pedal apparatus for a percussion instrument as claimed in claim 1, wherein the second end of the transmission mechanism includes a second position adjustment mechanism for adjusting a connected position between the second end and the pivot shaft.

12. The pedal apparatus for a percussion instrument as claimed in claim 11, wherein the second position adjustment mechanism includes a plurality of engaging projections for adjusting the connected position between the second end and the pivot shaft stepwise along a length of a pivoting-motion transmitting path of the transmission mechanism.

13. The pedal apparatus for a percussion instrument as claimed in claim 12, wherein the second position adjustment mechanism includes an elongated hole extending along a length of a pivoting-motion transmitting path of the transmission mechanism from the first end to the second end, and the second position adjustment mechanism connects the second end of the transmission mechanism to the pivot shaft by an engaging member inserted and engaged in both a desired position of the elongated hole of the second position adjustment mechanism and an engaging hole formed in the pivot shaft and positioned in superimposed alignment with the desired position of the elongated hole of the second position adjustment mechanism.

14. The pedal apparatus for a percussion instrument as claimed in claim 1, wherein the transmission mechanism comprises a chain, a link mechanism or a belt.
